(19) United States
(12) Patent Application Publication
(10) Pub. No.: US 2015/0089051 A1
(43) Pub. Date: Mar. 26, 2015

(54) DETERMINING A TIME OFFSET

(71) Applicant: Juha Petteri Ojanperä, Nokia (FI)

(72) Inventor: Juha Petteri Ojanperä, Nokia (FI)

(73) Assignee: Nokia Corporation, Espoo (FI)

(21) Appl. No.: 14/385,991

(22) PCT Filed: Mar. 28, 2012
(86) PCT No.: PCT/IB2012/051478

§ 371 Date: Sep. 17, 2014

(51) Int. Cl. H04L 12/26

(52) U.S. Cl. CPC H04L 43/0852
USPC 709/224

(57) ABSTRACT

A method comprises storing primary time-stamped media and secondary time-stamped media provided by a first device; storing primary time-stamped media and secondary time-stamped media provided by a second device; and using the secondary time-5 stamped media from the first and second devices to determine a time offset between the primary media from the first and second devices.

### FIELD OF THE INVENTION

This invention relates to determining a time offset.

### BACKGROUND TO THE INVENTION

It is known to distribute devices around an audio space and use them to record an audio scene. Captured signals are transmitted and stored at a rendering location, from where an end user can select a listening point based on their preference from the reconstructed audio space. This type of system presents numerous technical challenges.

In order to create an immersive sound experience, the content to be rendered must first be aligned. If multiple devices start recording an audio visual scene at different times from different perspectives, then it cannot be easily determined whether they are in fact recording the same scene.

Alignment can be achieved using a dedicated synchronization signal to time stamp the recordings. The synchronization signal can be some special beacon signal (e.g., clappers) or timing information obtained through GPS satellites. The use of a beacon signal typically requires special hardware and/or software installations, which limits the applicability of multi-user sharing service. GPS is a good solution for synchronization but is available only when a GPS receiver is present in the recording devices and is rarely available in indoor environments due to attenuation of the GPS signals.

Alternatively, various methods of correlating audio signals can be used for synchronization of those signals.

These techniques do not necessarily fit well to the multi-device environment. In particular, the amount of correlation calculations increases as the number of recordings increases, and typically the increase is exponential rather than linear. Furthermore, the time skew between multiple content recordings typically need to be limited to some tens of seconds at maximum otherwise the computational complexity is overwhelming.

Another class of synchronization is to use NTP (Network Time Protocol) for time stamping the recorded content from multiple users. In this case, the local device clocks are synchronized against the NTP reference, which is global. However, NTP requires network connection, which may not be available in all situations, and typically some timing error is introduced into timestamps due to transmission delays.

### SUMMARY OF THE INVENTION

A first aspect of the invention provides a method comprising:
storing primary time-stamped media and secondary time-stamped media provided by a first device;
storing primary time-stamped media and secondary time-stamped media provided by a second device; and
using the secondary time-stamped media from the first and second devices to determine a time offset between the primary media from the first and second devices.

The method may further comprise a server using the secondary time-stamped media to determine a time offset between the primary media.

The method may further comprise a mobile device using the secondary time-stamped media to determine a time offset between the primary media.

The method may further comprise receiving the time-stamped secondary media as files. Alternatively, the method may further comprise receiving time-stamped secondary media as a stream.

The time-stamped secondary media may be continuous time-varying media. Alternatively, the time-stamped secondary media may be a characterisation of continuous time-varying media.

The method may further comprise receiving secondary media at the first device and providing time-stamped secondary media from the first device.

The secondary media received at the first device may be an over-the-air broadcast, for instance a radio broadcast. Alternatively, the secondary media may be an internet protocol broadcast, for instance a webcast.

The method may further comprise receiving primary media from the second device and receiving offset information from the first device.

The method may further comprise using the time offset to align primary media. Using the time offset to align the primary media may comprise applying the offset directly to the primary media. Alternatively, it may comprise using the offset to limit alignment searching in the primary media.

The method may further comprise the first device capturing the secondary media before capturing the primary media.

The method may further comprise the first device or the second device receiving a trigger to start capturing the primary media.

A second aspect of the invention provides a computer program comprising machine readable instructions that when executed by computing apparatus cause it to perform any of the methods as described above.

A third aspect of the invention provides apparatus comprising:
means for storing primary time-stamped media provided by a first device;
means for storing secondary time-stamped media provided by the first device;
means for storing primary time-stamped media provided by a second device;
means for storing secondary time-stamped media provided by the second device; and
an offset calculator configured to use the secondary time-stamped media from the first and second devices to determine a time offset between the primary media from the first and second devices.

All of the means for storing may be included in a server. The server may also include the offset calculator.

The means for storing primary time-stamped media provided by a first device and the means for storing primary time-stamped media provided by a second device may be provided by a server, the means for storing secondary time-stamped media provided by the first device may be provided by the first device, and the means for storing secondary time-stamped media provided by the second device and the offset calculator may also be provided by the first device.

The first device may be configured to send the calculated time offset to the server.

The time-stamped secondary media may be received as files. Alternatively, the time-stamped secondary media may be received as streams.

The time-stamped secondary media may be continuous time-varying media. Alternatively, the time-stamped secondary media may a characterisation of continuous time-varying media.

The apparatus may be configured to receive secondary media at the first device and provide time-stamped secondary media from the first device.

The secondary media received at the first device may be an over-the-air broadcast, for instance a radio broadcast. Alternatively, the secondary media may be an internet protocol broadcast, for instance a webcast.

The apparatus may be configured to cause primary media to be received from the second device and offset information to be received from the first device.

The apparatus may be configured to use the time offset to align primary media. The apparatus may be configured to use the time offset to align by being configured to apply the offset directly to the primary media. Alternatively, it may be configured to use the time offset to align the primary media by using the offset to limit alignment searching in the primary media.

The apparatus may be configured to cause the first device to capture the secondary media before capturing the primary media.
The apparatus may be configured to cause the first device or the second device to receive a trigger to start capturing the primary media.

A fourth aspect of the invention provides apparatus comprising:
a first memory configured to store primary time-stamped media provided by a first device;
a second memory configured to store secondary time-stamped media provided by the first device;
a third memory configured to store primary time-stamped media provided by a second device;
a fourth memory configured to store secondary time-stamped media provided by the second device; and
an offset calculator configured to use the secondary time-stamped media from the first and second devices to determine a time offset between the primary media from the first and second devices.

A server may include all of the first to fourth memories. The server may also comprise the offset calculator. Alternatively, a server may include the first and third memories and the first device may include the second and fourth memories and the offset calculator. Here. the first device may be configured to send the calculated time offset to the server.

The time-stamped secondary media may be received as files. Alternatively, the time-stamped secondary media may be received as streams.

The time-stamped secondary media may be continuous time-varying media. Alternatively, the time-stamped secondary media may a characterisation of continuous time-varying media.

The apparatus may be configured to receive secondary media at the first device and provide time-stamped secondary media from the first device.

The secondary media received at the first device may be an over-the-air broadcast, for instance a radio broadcast. Alternatively, the secondary media may be an internet protocol broadcast, for instance a webcast.

The apparatus may be configured to cause primary media to be received from the second device and offset information to be received from the first device.

The apparatus may be configured to use the time offset to align primary media. The apparatus may be configured to use the time offset to align by being configured to apply the offset directly to the primary media. Alternatively, it may be configured to use the time offset to align the primary media by using the offset to limit alignment searching in the primary media.

The apparatus may be configured to cause the first device to capture the secondary media before capturing the primary media.

The apparatus may be configured to cause the first device or the second device to receive a trigger to start capturing the primary media.

A fifth aspect of the invention provides a non-transitory computer-readable storage medium having stored thereon computer-readable code, which, when executed by computing apparatus, causes the computing apparatus to perform a method comprising:
storing primary time-stamped media and secondary time-stamped media provided by a first device;
storing primary time-stamped media and secondary time-stamped media provided by a second device; and
using the secondary time-stamped media from the first and second devices to determine a time offset between the primary media from the first and second devices.

The computer-readable code when executed may cause computing apparatus in a server to use the secondary time-stamped media to determine a time offset between the primary media.

The computer-readable code when executed may cause computing apparatus in a mobile device to use the secondary time-stamped media to determine a time offset between the primary media.

The computer-readable code when executed by computing apparatus may cause the time-stamped secondary media to be received as files. Alternatively, the computer-readable code when executed by computing apparatus may cause the time-stamped secondary media to be received as a stream.

The time-stamped secondary media may be continuous time-varying media. Alternatively, the time-stamped secondary media may be a characterisation of continuous time-varying media.

The computer-readable code when executed by computing apparatus may cause secondary media to be received at the first device and time-stamped secondary media to be provided from the first device.

The secondary media received at the first device may be an over-the-air broadcast, for instance a radio broadcast. Alternatively, the secondary media may be an internet protocol broadcast, for instance a webcast.

The computer-readable code when executed by computing apparatus may cause primary media to be received from the second device and offset information to be received from the first device.

The computer-readable code when executed by computing apparatus may cause the time offset to be used to align primary media. The computer-readable code when executed by computing apparatus may use the time offset to align by applying the offset directly to the primary media. Alternatively, it may be use the time offset to align the primary media by using the offset to limit alignment searching in the primary media.

The computer-readable code when executed by computing apparatus may cause the first device to capture the secondary media before capturing the primary media.

The computer-readable code when executed by computing apparatus may cause the first device or the second device to receive a trigger to start capturing the primary media.

A sixth aspect of the invention provides apparatus having at least one processor and at least one memory having computer-readable code stored thereon which when executed controls the at least one processor to perform a method comprising:
storing primary time-stamped media and secondary time-stamped media provided by a first device;
storing primary time-stamped media and secondary time-stamped media provided by a second device; and
using the secondary time-stamped media from the first and second devices to determine a time offset between the primary media from the first and second devices.

The computer-readable code that when executed may control the at least one processor to use the secondary time-stamped media to determine a time offset between the primary media is stored in at least one memory of a server and may control at least one processor of the server.

The computer-readable code that when executed may control the at least one processor to use the secondary time-stamped media to determine a time offset between the primary media is stored in at least one memory of a mobile device and may control at least one processor of the mobile device.

The computer-readable code when executed may control the at least one processor to perform a method comprising receiving the time-stamped secondary media as files. Alternatively, the computer-readable code when executed may control the at least one processor to perform a method comprising receiving time-stamped secondary media as a stream.

The time-stamped secondary media may be continuous time-varying media. Alternatively, the time-stamped secondary media may a characterisation of continuous time-varying media.

The computer-readable code when executed may control the at least one processor to receive secondary media at the first device and providing time-stamped secondary media from the first device.

The secondary media received at the first device may be an over-the-air broadcast, for instance a radio broadcast. Alternatively, the secondary media may be an internet protocol broadcast, for instance a webcast.

The computer-readable code when executed may control the at least one processor to receive primary media from the second device and receive offset information from the first device.

The computer-readable code when executed may control the at least one processor to use the time offset to align primary media. The computer-readable code when executed by computing apparatus may use the time offset to align by applying the offset directly to the primary media. Alternatively, it may be use the time offset to align the primary media by using the offset to limit alignment searching in the primary media.

The computer-readable code when executed may control at least one processor of the first device to capture the secondary media before capturing the primary media.

The computer-readable code when executed may control the at least one processor of the first device or the second device to receive a trigger to start capturing the primary media.

Other exemplary features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE DRAWINGS

FIG. 1 shows audio scene with N capturing devices;

FIG. 2 is a block diagram of an end-to-end system embodying aspects of the invention;

FIG. 3 shows details of some components of the FIG. 2 system according to some embodiments;

FIG. 4 shows details of some components of the FIG. 2 system according to some embodiments;

FIG. 5 is a flowchart illustrating operation of components of the FIG. 2 system according to embodiments described with reference to FIG. 3;

FIG. 6a is a flowchart illustrating operation of devices of the FIG. 2 system according to embodiments described with reference to FIG. 4; and

FIG. 6b is a flowchart illustrating operation of a server of the FIG. 2 system according to embodiments described with reference to FIG. 4.

### DETAILED DESCRIPTION OF EMBODIMENTS

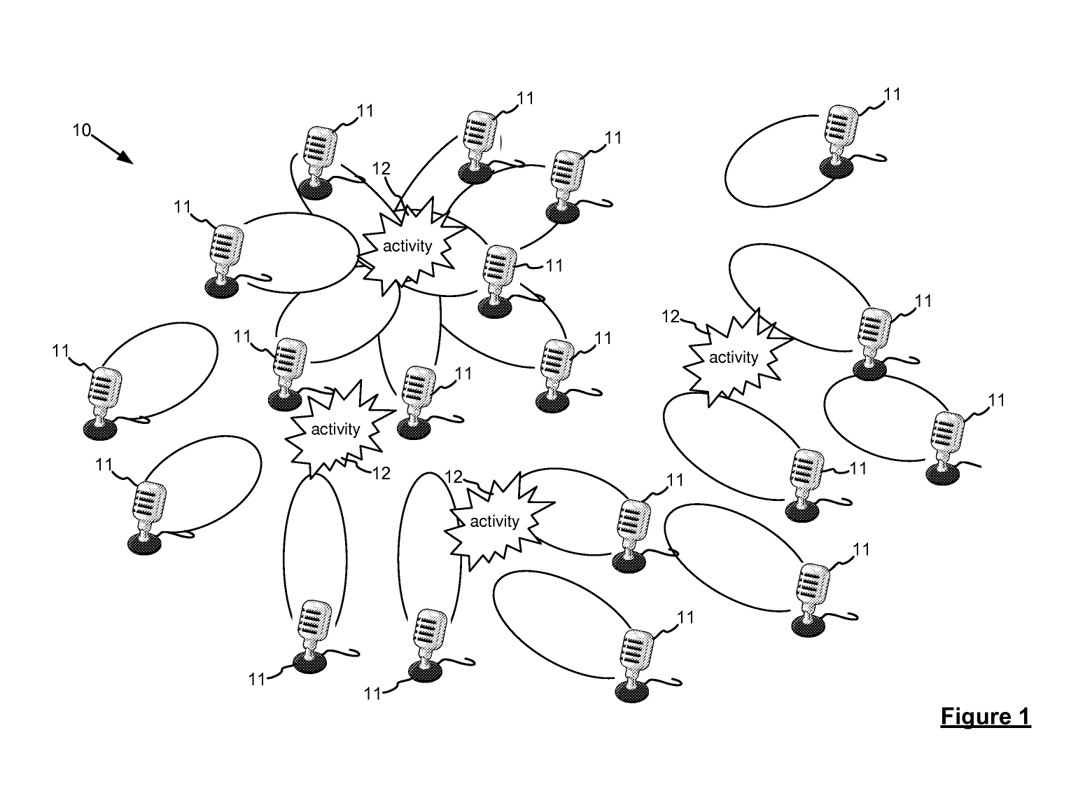

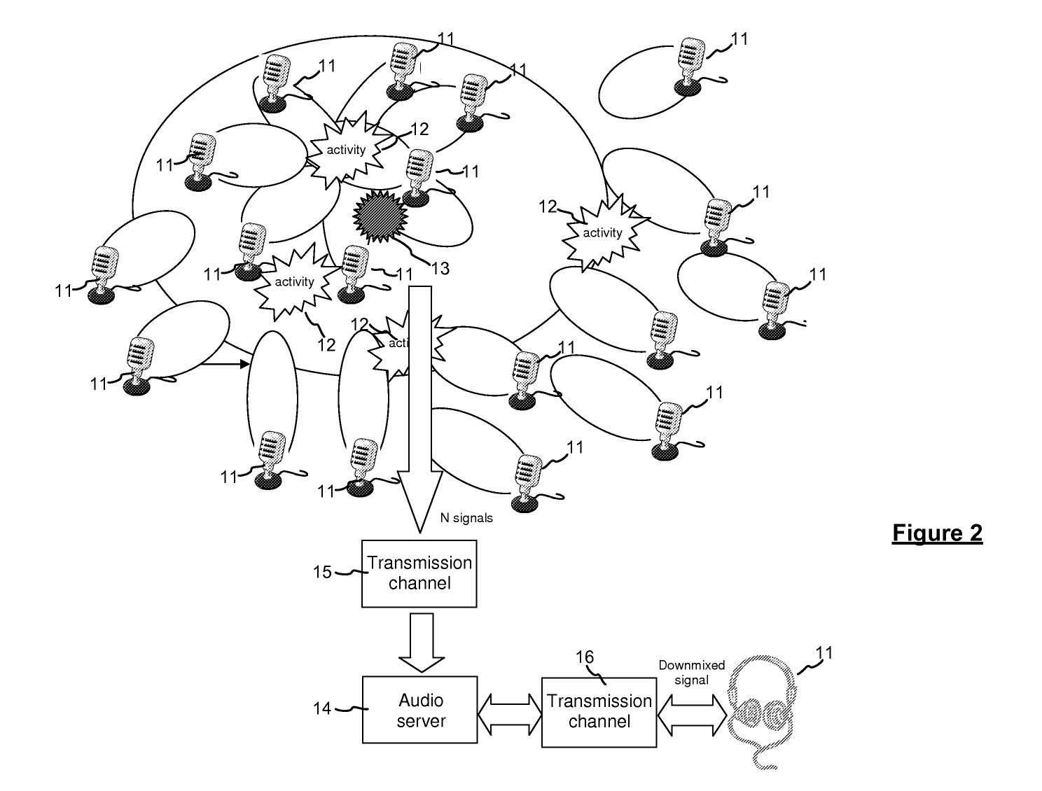

FIGS. 1 and 2 illustrate a system in which embodiments of the invention can be implemented. A system 10 consists of N devices 11 that are arbitrarily positioned within the audio space to record an audio scene. In these Figures, there are shown four areas of audio activity 12. The captured signals are then transmitted (or alternatively stored for later consumption) so an end user can select a listening point 13 based on his/her preference from a reconstructed audio space. A rendering part then provides one or more downmixed signals from the multiple recordings that correspond to the selected listening point. In FIG. 1, microphones of the devices 11 are shown to have highly directional beam, but embodiments of the invention use microphones having any form of directional sensitivity, which includes omni-directional microphones with little or no directional sensitivity at all. Furthermore, the microphones do not necessarily employ a similar beam, but microphones with different beams may be used. The downmixed signal(s) may be a mono, stereo, binaural signal or may consist of more than two channels, for instance four or six channels.

In an end-to-end system context, the framework operates as follows. Each recording device 11 records the audio/video scene and uploads or upstreams (either in real-time or non real-time) the recorded content to an server 14 via a channel 15. The upload/upstream process may also provides also positioning information about where the audio is being recorded. It may also provide the recording direction/orientation. A recording device 11 may record one or more audio signals. If a recording device 11 records (and provides) more than one signal, the direction/orientation of these signals may be different. The position information may be obtained, for example, using GPS coordinates, Cell-ID or A-GPS. Recording direction/orientation may be obtained, for example, using compass, accelerometer or gyroscope information.

Ideally, there are many users/devices 11 recording an audio scene at different positions but in close proximity. The server 14 receives each uploaded signal and keeps track of the positions and the associated directions/orientations.

The server 14 may control or instruct the devices 11 to begin recording a scene.

Initially, the audio scene server 14 may provide high level coordinates, which correspond to locations where user uploaded or upstreamed content is available for listening, to an end user device 11. These high level coordinates may be provided, for example, as a map to the end user device 11 for selection of the listening position. The end user device 11 or e.g. an application used by the end user device 11 is has functions of determining the listening position and sending this information to the audio scene server 14. Finally, the audio scene server 14 transmits the downmixed signal corresponding to the specified location to the end user device 11. Alternatively, the server 14 may provide a selected set of downmixed signals that correspond to listening point and the end user device 11 selects the downmixed signal to which he/she wants to listen. Furthermore, a media format encapsulating the signals or a set of signals may be formed and transmitted to the end user devices 11.

Embodiments of this specification relate to enabling immersive person-to-person communication including also video and possibly synthetic content. Maturing 3D audio-visual rendering and capture technology facilitates a new dimension of natural communication. An ‘all-3D’ experience is created that brings a rich experience to users and brings opportunity to businesses through novel product categories.

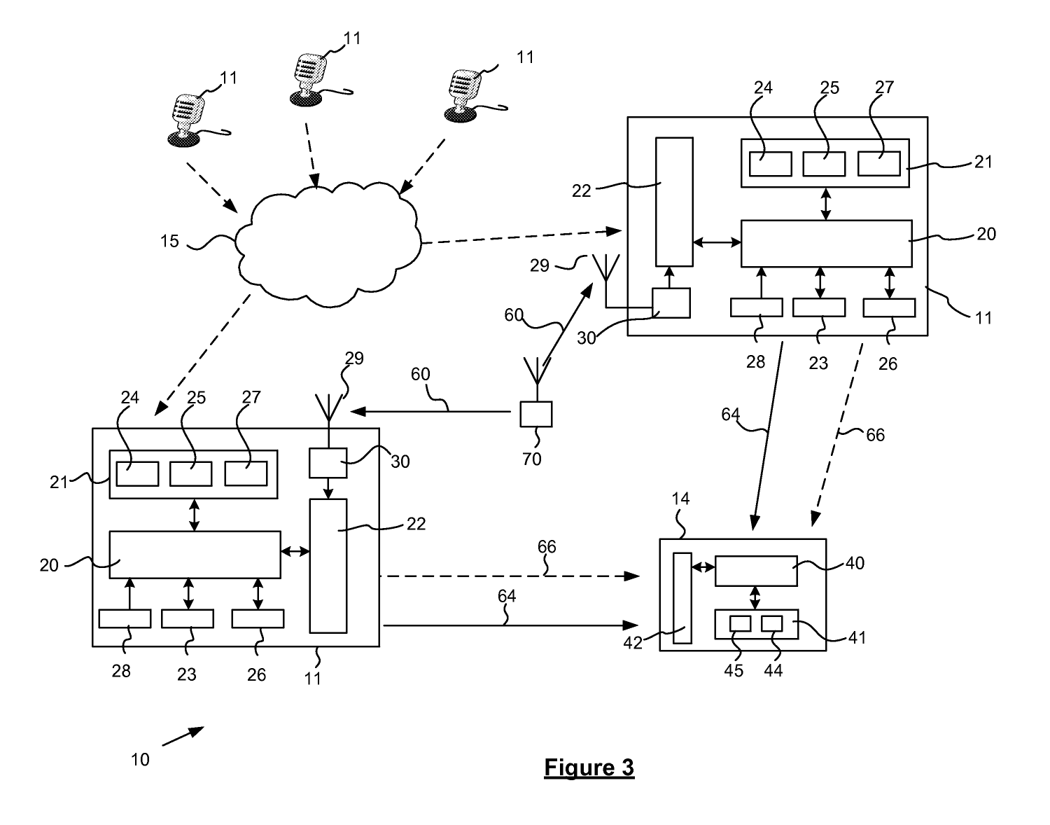

To be able to provide compelling user experience for the end user, the multi-user content itself must be rich in nature. The richness typically means that the content is captured from various positions and recording angles. The richness can then be translated into compelling composition content where content from various users are used to re-create the timeline of the event from which the content was captured. In order to achieve accurate rendering of this rich 3D content, accurate positions of the sound recording devices must be recorded. FIG. 3 shows a schematic Nock diagram of a system 10 according to embodiments of the invention. Reference numerals are retained from FIGS. 1 and 2 for like elements.

In FIG. 3, multiple end user recording devices 11 are connected to a server 14 by a first transmission channel or network 15. The user devices 11 are used for detecting an audio/visual scene for recording. The user devices 11 may record the scene and store it locally for uploading later. Alternatively, they may transmit the audio and/or video in real time, in which case they may or may not also store a local copy. The recorded scene may be audio media with no video, video media with no audio, or audio and video media. The audio and/or video recording shall henceforth be referred to as the “primary media”. In embodiments wherein primary media is solely audio, the audio may be recorded at 48 kHz. The captured audio may be encoded at a lower sampling rate, for example 32 kHz to reduce the resulting file size. The user devices 11 are referred to as recording devices 11 because they record audio and/or video, although they may not permanently store the audio and/or video locally.

The user devices 11 are also configured to record secondary time-stamped media 60 when controlled to do so. The secondary time-stamped media 60 is emitted by and received from a pre-determined source 70. In some exemplary embodiments, the pre-determined source 70 is a radio broadcast transmitter, for instance an FM (frequency modulation) radio station transmitter. Radio broadcasts are a type of over-the-air broadcast. In these embodiments, the secondary media is an FM radio signal. In the UK, FM radio stations may be present anywhere in the range of 88 to 108 MHz. In alternative embodiments, the pre-determined source is a webcaster that is connected to the device 11 by a packet-switched network such as the Internet. In these embodiments, the secondary media is a webcast stream. Broadcast radio and webcasts are suitable for use by embodiments of the invention because they can provide accuracy of timing to within some tens of milliseconds. Webcasts are commonly referred to as Internet radio because they are equivalent to radio broadcasts, although no radio link is required. In the case of mobile devices 11, a radio link is used for the last hop from the base station to the mobile.

Each of the recording devices 11 is a communications device equipped with a microphone 23 and loudspeaker 26. Each device 11 may for instance be a mobile phone, smartphone, laptop computer, tablet computer, PDA, personal music player, video camera, stills camera or dedicated audio recording device, for instance a dictaphone or the like.

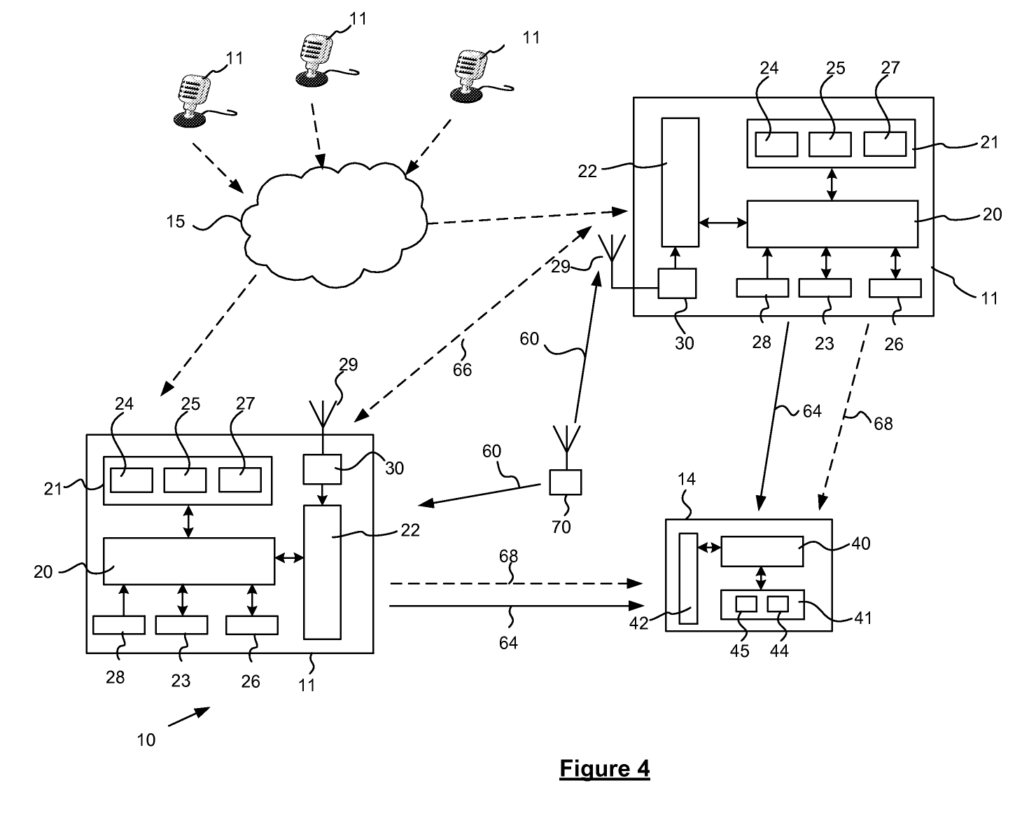

The recording device n includes a number of components including a processor 20 and a memory 21. The processor 20 and the memory 21 are connected to the outside world by an interface 22. The interface 22 is capable of transmitting and receiving according to multiple communication protocols. For example, the interface may be configured to transmit and receive according to one or more of the following: wired communication, Bluetooth, WiFi, and cellular radio. Suitable cellular protocols include GSM, GPRS, 3G, HSXPA, LTE, CMDA etc. The interface is further connected to an RF antenna 29 through a frequency modulation decoder 30. The interface is configured to transmit primary media to the server 14 along a channel 64. In an exemplary embodiment, the interface is further configured to transmit secondary media to the server 14 along a channel 66. In an alternative embodiment (as shown in FIG. 4), the interface is further configured to transmit a time offset value to the server 14 along a channel 68. At least one microphone 23 is connected to the processor 20. The microphone 23 is to some extent directional. If there are multiple microphones 23, they may have different orientations of sensitivity. The processor is also connected to a loudspeaker 26.

The processor is further connected to a timing device 28, which here is a clock. In one exemplary embodiment, the clock 28 maintains a local time using timing signals transmitted by a base station (not shown) of a mobile telephone network. The clock 28 may alternatively be maintained in some other way.

The memory 21 may be a non-volatile memory such as read only memory (ROM) a hard disk drive (HDD) or a solid state drive (SSD). The memory 21 stores, amongst other things, an operating system 24, at least one software application 25, and software for streaming internet radio 27.

The memory 21 is used for the temporary storage of data as well as permanent storage. Alternatively, there may be separate memories for temporary and non-temporary storage, such as RAM and ROM. The operating system 24 may contain code which, when executed by the processor 20 in conjunction with the memory 25, controls operation of each of the hardware components of the device 11.

The one or more software applications 25 and the operating system 24 together cause the processor 20 to operate in such a way as to achieve required functions. In this case, the functions include processing video and/or audio data, and may include recording it.

The content server 14 includes a processor 40, a memory 41 and an interface 42. The interface 42 may receive data files and streams from the recording devices 11 by way of intermediary components or networks. Within the memory 41 are stored an operating system 44 and one or more software applications 45.

The memory 41 may be a non-volatile memory such as read only memory (ROM) a hard disk drive (HDD) or a solid state drive (SSD). The memory 41 stores, amongst other things, an operating system 44 and at least one software application 45. The memory 41 is used for the temporary storage of data as well as permanent storage. Alternatively, there may be separate memories for temporary and non-temporary storage, e.g. RAM and ROM. The operating system 44 may contain code which, when executed by the processor 40 in conjunction with the memory 45, controls operation of each of the hardware components of the server 44.

The one or more software applications 45 and the operating system 44 together cause the processor 40 to operate in such a way as to achieve required functions. As is explained below, the required functions include calculating a time offset between secondary media. The functions may also include applying the calculated offset to a primary media.

Each of the user devices 11 and the content server 14 operate according to the operating system and software applications that are stored in the respective memories thereof. Wherein the following one of these devices is said to achieve a certain operation or provide a certain function, this is achieved by the software and/or the operating system stored in the memories unless otherwise stated. Audio and or video recorded by a recording device 11 is a time-varying series of data. The audio may be represented in raw form, as samples. Alternatively, it may be represented in a non-compressed format or compressed format, for instance as provided by a codec. The choice of codec for a particular implementation of the system may depend on a number of factors. Suitable codecs may include codecs that operate according to audio interchange file format, pulse-density modulation, pulse-amplitude modulation, direct stream transfer, or free lossless audio coding or any of a number of other coding principles. Coded audio represents a time-varying series of data in some form.

Primary media may be represented in raw form or in coded form.

Secondary media may be represented in raw form, coded form, or by a characterisation of the media that defines key features but does not allow the media to be reproduced in a user-consumable form.

FIG. 4 shows an alternative schematic Nock diagram of a system 10 according to embodiments of the invention. Reference numerals are retained from FIGS. 1, 2 and 3 for like elements.

In FIG. 4, operation is the same as that of FIG. 3, with the following exceptions. In FIG. 4, secondary media is transmitted from the first device 11 to the second device 11 along a channel 66. Also in FIG. 4, the interface 22 of the second device is configured to transmit a time offset value to the server 14 along a channel 68.

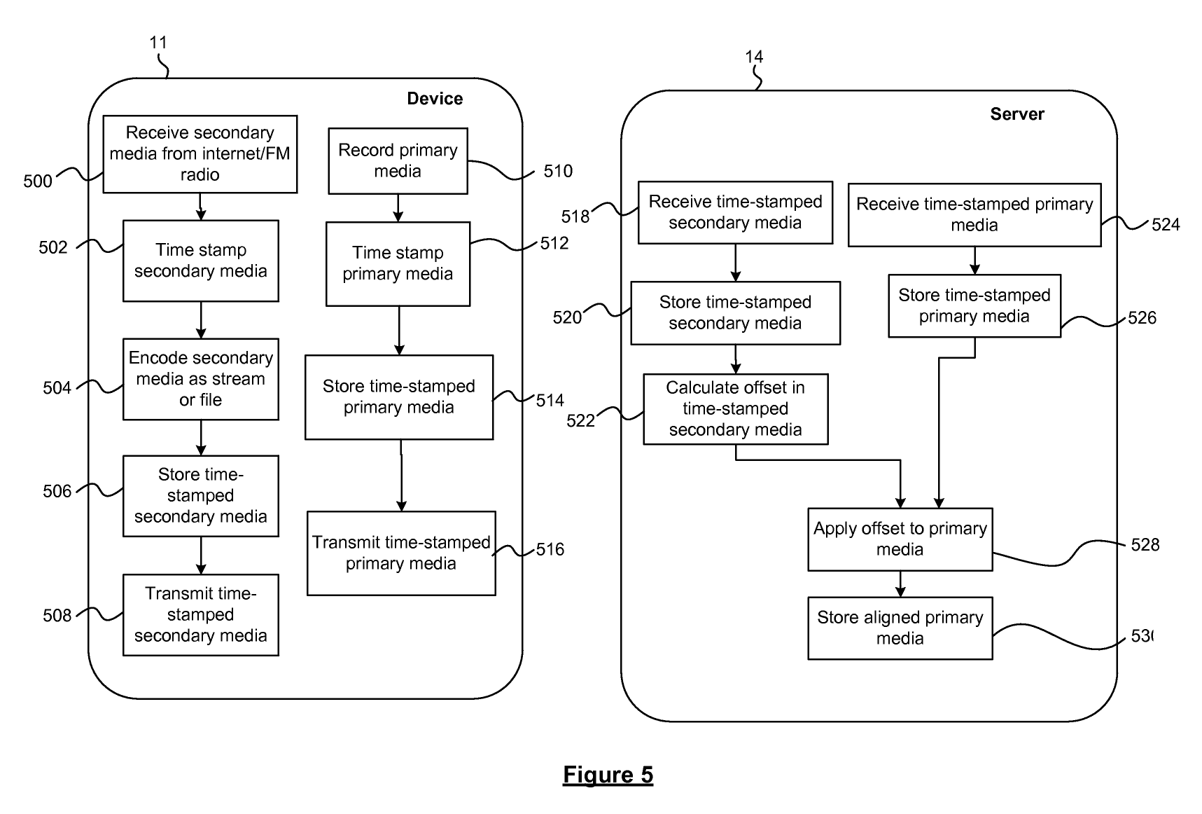

FIG. 5 illustrates operation of user devices 11 and the server 14 according to some embodiments of the invention. The embodiments utilise two user devices 11, however, both operate in the same way and thus only one device 11 is shown. The user device 11 serves to capture and timestamp an audio and/or video scene (primary media), receive and time-stamp a secondary media stream, and transmit both the timestamped primary and secondary media to the server 14. The server 14 calculates an offset in the secondary media and applies it to the primary media. In this way the primary media are aligned.

First, in step 500, the user device 11 receives secondary media. The secondary media may for instance be an FM radio broadcast, for example from a radio station broadcasting at 105 MHz, or an internet radio stream. The FM or Internet radio station each device 11 is tuned into can be pre-defined. Alternatively, some signalling may occur between devices 11 specifying the common radio station.

In step 502, the secondary media is time stamped using the device's 11 internal clock 28. Time stamps may be in any suitable form, for instance in the UTC (Coordinated Universal Time) format. Time stamping involves embedding the start time of the secondary media recording into the resulting file or stream. Time stamps may also be provided for other moments in the primary media.

In step 504 the time-stamped secondary media is processed. The processing of the recorded signal may take many forms such as encoding it using audio coding solutions such as MP3 or AAC. The recorded signal may alternatively transformed to another signal domain without the need for the coding. For example, processing may involve representing features from the signal and storing only these representations. Processing the secondary media may involve preparing the data stream for streaming.

The secondary media may be stored permanently or semi-permanently in memory 21 in step 506. Alternatively, the secondary media is not stored in the device 11.

In step 508 the time-stamped secondary media is transmitted to the server 14 along with a device identifier. Transmission can be of one or more files or as a stream.

In step 510, the device 11 records a scene. The recording may be audio, video, or both. The recording is primary media. Step 510 may be executed simultaneously with, before or after step 500. Put another way, the secondary media can be captured simultaneously with the primary media. There may be full or only partial overlap of capture. Alternatively, the secondary media and the primary media may be captured one after the other. There may or may not be a significant gap between capturing the primary media and the secondary media.

In step 512 the primary media is time stamped using the device's 11 internal clock 28. Time stamps may be in any suitable form, for instance in the UTC (Coordinated Universal Time) format. Time stamping involves embedding the start time of the secondary media recording into the resulting file or stream. Time stamps may also be provided for other moments in the primary media.

The time-stamped primary media may then be stored in memory 21 in step 514. Here, the primary media is uploaded to the server 14 at a later time, for example when the device 11 is connected to a WiFi network. In this case, HTTP uploading or FTP or any other suitable scheme may be used to implement uploading. In alternative embodiments the primary media is not stored within the device 11 but is streamed live to the server 14, any suitable streaming schemes may be used. For instance, MPEG-4 audio and video may be included in RTP payloads.

In step 516 the time-stamped primary media is transmitted to the server 14 along with a device 11 identifier along channel 64.

Steps 500 to 516 are also carried out on a second device 11. The steps may be carried out simultaneously on both devices 11, or the process may start on one device 11 before it starts on another. In either situation, an overlap in secondary media is needed in order for a time offset to be calculated. In some embodiments, the start of primary media capturing on one device 11 signals the second device 11 to start capturing primary media. In alternative embodiments the second device 11 monitors the primary media capturing of the first device 11 and initiates its own recording when needed. In further alternative embodiment, the signalling for the second device 11 to begin primary media capture is transmitted by a server (not shown) that monitors the event, or scene, and knows when to initiate the primary source capturing among devices present in the event. Devices 11 subscribe to this server with parameters associated with the event.

Next, in step 518, the server 14 receives the time-stamped secondary media from at least two user devices 11. The secondary media is stored in step 520. Time-stamped primary media is received in step 524 from the same devices 11. The primary media is stored at step 526.

In step 522 the secondary media from the first user device and the second user device is aligned. The alignment defines the time offset that is applied to one of the sources in order to make content from both user devices 11 synchronous. The exact method for determining the time offset is outside the scope of this specification but various prior art techniques can be used. For the purpose of illustration, let x_{d} represent the secondary media from the user devices n. Furthermore, let d={0,1}, that is, the content rendering server 14 occupies content from two different user devices n that need to be aligned. Assume that x₀ started xt time units after start of x₁. If the start time of x₁ is startTS₁, then the start time of x₀ is startTS₁+xt (both must use the same time unit).

The offset is applied to the primary media at step 528. The successfully aligned secondary media is used as a reference point to find approximately the overlapping content segment of the primary media for both user devices 11.

For the first user device 11, the secondary media capturing takes place between t₁ and t₂. For the second user device 11, the secondary media capturing takes place between u₁ and u₂. The primary media capturing occurs between t₃ and t₄ for the first user device n. The primary media capturing for the second user device 11 occurs between u₃ and u₄.

Since the time offset of the primary media is tOffset₁=xt and, once aligned, time offset of the secondary media is tOffset₂=0, the start times for the primary media capturing are therefore:

startTS_{—}AVᵢ=tOffsetᵢ+tDiff_{0,1}+cDriftᵢ+zᵢ+xᵢ,0≦i<2

tDiff_{n,m}=min(tDiffₙ, . . . tDiffₘ₋₁) (1)

where zᵢ includes the various delays (buffering delay, etc) that are associated with the secondary media recording, xᵢ includes the various delays that are associated with the primary media recording, cDriftᵢ represents the clock drift of the device (that may range from few microseconds up to several milliseconds).

Furthermore,

tDiffᵢ=startTS_{—}AV_localᵢ−startTS_{—}2_localᵢ (2)

describes the start time difference between the primary and the secondary media signal capturing using the devices' local time.

The overlapping segment for the primary media is therefore:

overlapSegment_{0,1}=endTS_{0,1}−startTS_{0,1}

startTS_{0,1}=max(startTS_{—}AV₀,startTS_AV₁)

endTS_{0,1}=min(endTS_{—}AV₀,endTS_{—}AV₁)

endTS_{—}AV₀=startTS_{—}AV₀+AV₀_{_{—}}duration

endTS_{—}AV₁=startTS_{—}AV₁+AV₁_{_{—}}duration (3)

where endTS_AVᵢ and AVᵢ_{_{—}}duration describe the end time and the duration of the primary media for the i^{th} device, respectively. Furthermore, min( ) and max( ) return the minimum and maximum value of the specified values, respectively.

The primary media is aligned with following parameters:

### Device1:

tAlignDuration₀=min(overlapSegment_{0,1},AV₀_{_{—}}duration)

tAlignOffset₀=0

### Device2:

tAlignDuration₁=min(overlapSegment_{0,1},AV₁_{_{—}}duration)

tAlignOffset₁=startTS_{—}AV₀−startTS_{—}AV₁ (4)

The primary media segment for the first device that is to be aligned is from t₃ to t₃+tAlignDuration₀ and the primary media segment for the second device that is to be aligned is from u₃+tAlignOffset₁ to u₃+tAlignOffset₁+tAlignDuration₁.

The alignment window that defines the maximum skew between the content is set to skew_{0,1}=2.max(cDrift₀+z₀+x₀, cDrift₁+z₁+x₁). In practise the maximum skew is difficult to accurately measure so it is preferred to use some pre-defined threshold that absorbs of the inaccuracies, for example, skew_{0,1}=3 seconds. In other words, the primary media is aligned such that the alignment needed for the content between two devices is at maximum 3 seconds.

Again, the exact method for determining the time offset for the primary content with specified parameters is outside the scope of this specification but various techniques are suitable.

Finally, in step 530, the aligned primary media is stored in memory 41. The primary media from multiple devices can now be jointly processed for various rendering and analysis purposes.

Step 528 may involve simply applying the offset calculated in step 522 to align the primary media.

Alternatively, step 528 may involve using the offset calculated in step 522 as an approximate offset, comparing the two primary media to one another to determine an accurate offset between the primary media, and applying the accurate offset when aligning the aligned primary media and then storing it at step 530. In this alternative, the approximate offset is used to limit an alignment algorithm used to calculate the accurate offset. In this way, the use of the approximate offset in the alignment of the primary media reduces the amount of calculation required to perform alignment, since the approximate offset reduces misalignment and since greater misalignment requires more processing steps in order to provide alignment. In the alternative, the alignment process can be considered to be a two-stage process. Firstly, an offset is calculated by an alignment algorithm applied to the secondary media, and secondly an accurate offset is calculated by a second algorithm (or second instance of the first algorithm) using the offset and the primary media.

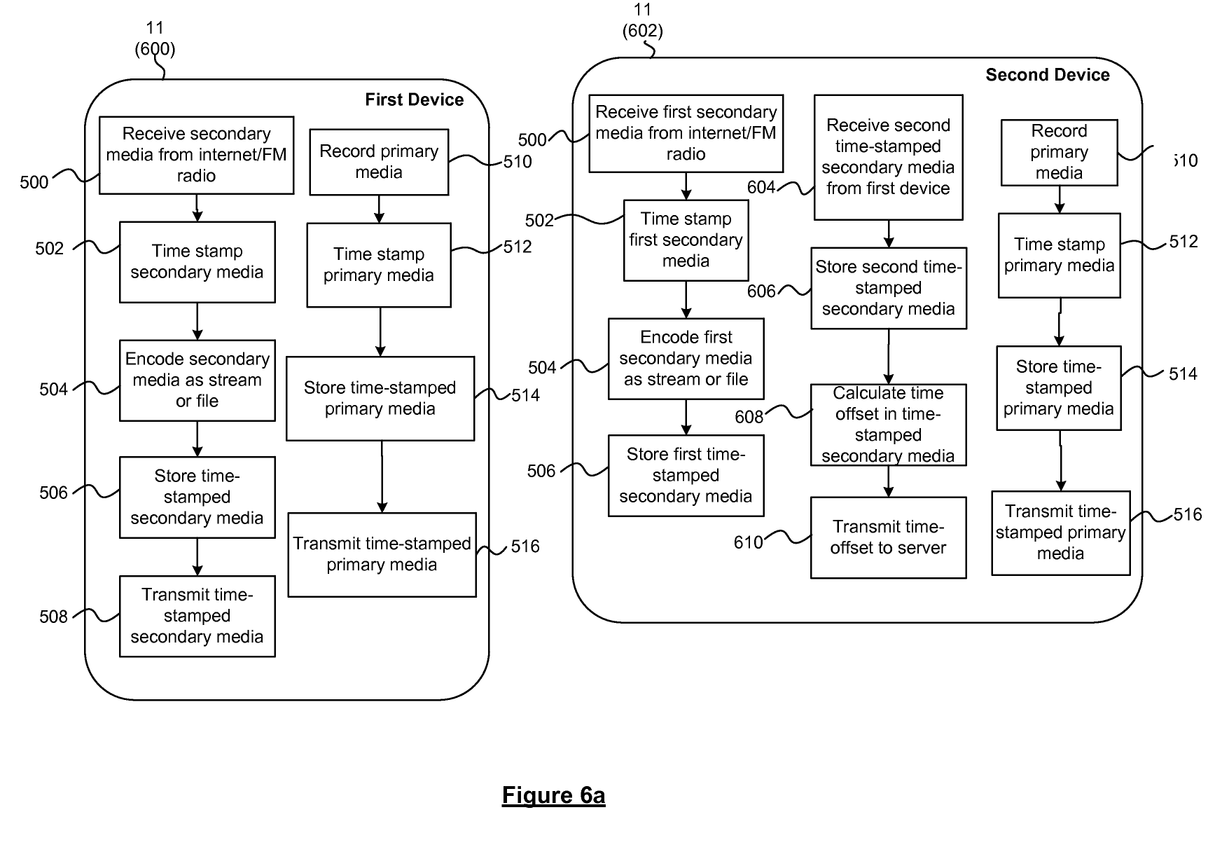

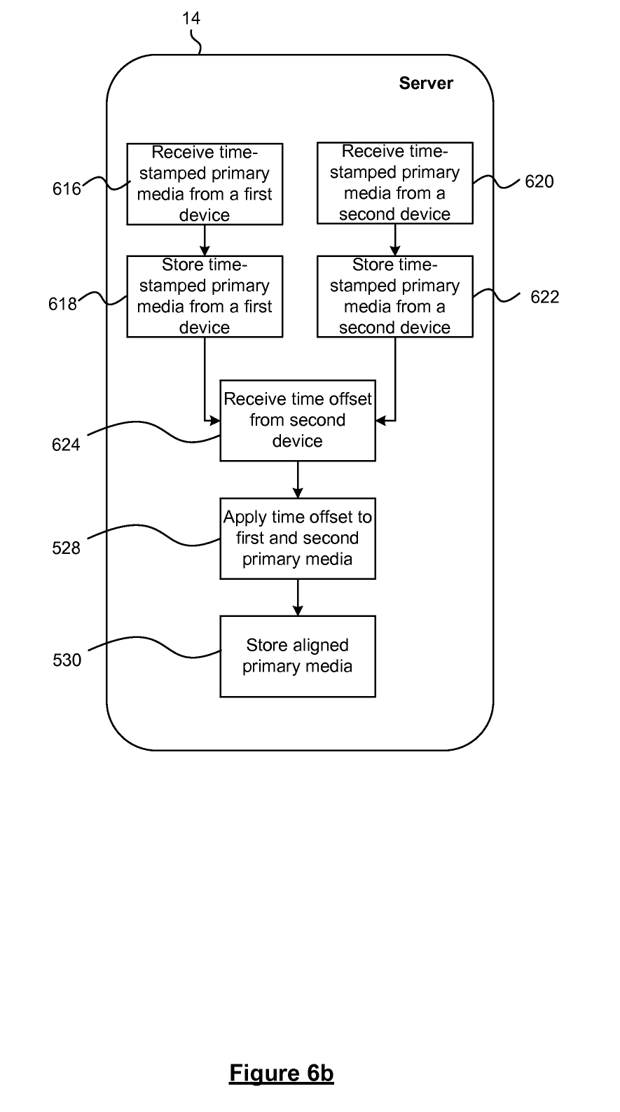

FIG. 6a illustrates operation of user devices 11 according to different embodiments of the invention depicted in FIG. 4. Reference numerals are retained from FIG. 5 for like steps.

In contrast to the embodiment shown in FIG. 5, the calculation of the time offset in secondary media is performed by a user device 11. The first user device 600 serves to capture an audio and/or video scene (primary media), and download and time-stamp a secondary media stream. The primary media is transmitted to the server 14 over the channel 64. The secondary media is transmitted to the second user device 602 along a different channel 66. The second user device 602 performs the same operation as the first user device 600 with the addition of steps 604-610. In these steps, the time offset between the secondary media of both devices 11 is calculated. This is the carried out in the same way as described above in relation to steps 518, 520 and 522 of FIG. 5. The time offset is transmitted along with device identifiers to the server 14 over a further channel 68.

The server 14 operation of the embodiment of FIG. 4 is shown in FIG. 6b. Here, the server 14 receives primary media from first and second devices 11 in steps 616 and 620. These steps may or may not occur synchronously. The primary media are stored within memory 41 in steps 618 and 622. The time offset value is received from the second device 602 in step 624. This step may occur before, after or simultaneously with steps 616 and 620. The time offset is then applied to the primary media in the same way as described above in relation to steps 528 and 530 of the FIG. 5 embodiment.

In a further embodiment, the server 14 further comprises an RF antenna and radio receiver and demodulator (not shown) or a webcast decoder and a clock (not shown). When a device 11 begins receiving a secondary media, it signals the server 14 to also begin receiving the secondary media, using its radio receiver or webcast decoder. The server 14 time stamps the secondary media that it has received through its radio receiver or webcast decoder. Upon reception of a raw, coded or characterised secondary media from a device 11, the server 14 calculates the time offset between its internal clock and that of the device. The server 14 performs the same operation in respect of secondary media received from a second device, to determine an offset between the server's clock and the clock of the secondary device. Both offsets are then used to align the primary media from the two devices. In this embodiment, the offset between the secondary media from the two devices can be said to have been determined indirectly, by comparison of each with the same secondary media received directly by the server 14. In another embodiment, an offset to the first device is determined by the server 14 using a certain radio station or webcast and an offset to the second device is determined by the server 14 using a different radio station or webcast. Because the server 14 timestamps the secondary media using its internal clock in both cases, this allows accurate determination of an offset between the first and second devices.

Apparatus according to all of the embodiments can be said to comprise four memories. A first memory is configured to store primary time-stamped media provided by a first device. A second memory is configured to store secondary time-stamped media provided by the first device. A third memory is configured to store primary time-stamped media provided by a second device. A fourth memory is configured to store secondary time-stamped media provided by the second device. An offset calculator is configured to use the secondary time-stamped media from the first and second devices to determine a time offset between the primary media from the first and second devices.

Some of the memories can be provided within the same device, and even as part of the same physical memory. For instance, the memory 41 in the server may store all of the secondary and primary media, as in the embodiments of FIG. 5. In the embodiments of FIGS. 6a and 6b, the second and fourth memories may be part of the first device 600. Of course, where content is stored at least transiently at multiple locations, the memory may be constituted by memory in two different apparatuses.

Numerous positive effects and advantages are provided by the above described embodiments of the invention.

The content alignment process is mostly independent of the audio space and the characteristics that are being recorded. By using broadcast radio or a webcast, alignment is applied to at least one audio source that is more or less free from the background noise and the audio level changes that are typically dominantly present in live recordings.

The use of common secondary media such as broadcast radio or internet radio and aligning through time stamps provides a relatively simple system. Using such common media means that no special timecodes or any other special preparations are required for the content alignment. The system may not require any special hardware on the part of the recording devices 11, such as clappers, and the invention may be implemented by firmware or software updates.

An effect of the above-described embodiments is the possibility to improve the resultant rendering of multi-user scene capture due to the accurate synchronisation of devices. This can allow an experience that creates a feeling of immersion, where the end user is given the opportunity to listen/view different compositions of the audio-visual scene. In addition, this can provided in such a way that it allows the end user to perceive that the compositions are made by people rather than machines/computers, which typically tend to create quite monotonous content.

The invention is not limited to the above-described embodiments and various alternatives will be envisaged by the skilled person and are within the scope of this invention, unless specifically precluded by the claims.

1-71. (canceled)

72. A method comprising:
storing primary time-stamped media and secondary time-stamped media provided by a first device;
storing primary time-stamped media and secondary time-stamped media provided by a second device; and
using the secondary time-stamped media from the first and second devices to determine a time offset between the primary media from the first and second devices.

73. The method of claim 72, comprising a server using the secondary time-stamped media to determine a time offset between the primary media.

74. The method of claim 72, comprising a mobile device using the secondary time-stamped media to determine a time offset between the primary media.

75. The method of claim 72, comprising receiving the time-stamped secondary media as files.

76. The method of claim 72, comprising receiving time-stamped secondary media as a stream.

77. The method of claim 72, wherein the time-stamped secondary media is continuous time-varying media.

78. The method of claim 72, wherein the time-stamped secondary media is a characterisation of continuous time-varying media.

79. The method of claim 72, comprising receiving secondary media at the first device and providing time-stamped secondary media from the first device.

80. The method of claim 72, wherein the secondary media received at the first device is an over-the-air broadcast, for instance a radio broadcast.

81. The method of claim 72, wherein the secondary media is an internet protocol broadcast, for instance a webcast.

82. The method of claim 72, comprising receiving primary media from the second device and receiving offset information from the first device.

83. The method of claim 72, comprising using the time offset to align primary media.

84. The method of claim 72, comprising the first device capturing the secondary media before capturing the primary media.

85. The method of claim 72, comprising the first device or the second device receiving a trigger to start capturing the primary media.

86. Apparatus, the apparatus having at least one processor and at least one memory having computer-readable code stored thereon which when executed controls the at least one processor to:
store primary time-stamped media and secondary time-stamped media provided by a first device;
store primary time-stamped media and secondary time-stamped media provided by a second device; and
use the secondary time-stamped media from the first and second devices to determine a time offset between the primary media from the first and second devices.

87. The apparatus of claim 86 wherein the computer-readable code when executed controls the at least one processor to use the secondary time-stamped media to determine a time offset between the primary media is stored in at least one memory of a server and controls at least one processor of the server.

88. The apparatus of claim 86, wherein the computer-readable code when executed controls the at least one processor to use the secondary time-stamped media to determine a time offset between the primary media is stored in at least one memory of a mobile device and controls at least one processor of the mobile device.

89. The apparatus of claim 86, wherein the computer-readable code when executed controls the at least one processor to receive the time-stamped secondary media as files.

90. The apparatus of claim 86, wherein the computer-readable code when executed controls the at least one processor to receive time-stamped secondary media as a stream.

91. The apparatus of claim 86, wherein the time-stamped secondary media is continuous time-varying media.

92. The apparatus of claim 86, wherein the time-stamped secondary media is a characterisation of continuous time-varying media.

93. The apparatus of claim 86, wherein the computer-readable code when executed controls the at least one processor to receive secondary media at the first device and provide time-stamped secondary media from the first device.

94. The apparatus of claim 86, wherein the secondary media received at the first device is an over-the-air broadcast, for instance a radio broadcast.

95. The apparatus of claim 86, wherein the secondary media is an internet protocol broadcast, for instance a webcast.

96. The apparatus of claim 86, wherein the computer-readable code when executed controls the at least one processor to receive primary media from the second device and receive offset information from the first device.

97. The apparatus of claim 86, wherein the computer-readable code when executed controls the at least one processor to use the time offset to align primary media.

98. The apparatus of claim 86, wherein the computer-readable code when executed controls the at least one processor to capture the secondary media before capturing the primary media.

99. The apparatus of claim 86, wherein the computer-readable code when executed controls at least one processor of the first device or the second device to receive a trigger to start capturing the primary media.
